(19) United States
(12) Patent Application Publication
(10) Pub. No.: US 2011/0058778 A1
(43) Pub. Date: Mar. 10, 2011

(54) CABLE INCLUDING STRAIN-FREE FIBER AND STRAIN-COUPLED FIBER

(76) Inventor: Brian Herbst, Easley, SC (US)

(21) Appl. No.: 12/990,882

(22) PCT Filed: May 10, 2010
(86) PCT No.: PCT/US10/34203

§ 371 Date: Nov. 3, 2010

Related U.S. Application Data
(60) Provisional application No. 61/176,620, filed on May 8, 2009.

(51) Int. Cl. G02B 6/44

(52) U.S. Cl. 385/100

(57) ABSTRACT

A cable including a strain free and strain coupled optical fiber is provided. The disclosed cable provides a single device that can perform both strain and temperature measurements in a distributed manner and provide accurate results for the actual strain on the cable.

### CROSS-REFERENCE TO RELATED PATENT APPLICATION

This application claims priority from U.S. Provisional Application No. 61/176,620 filed on May 8, 2009, the disclosure of which is incorporated herein by reference in its entirety.

### BACKGROUND

1. Technical Field

Apparatuses consistent with the present disclosure relate to an optical fiber cable, and more particularly to a cable having strain-coupled and strain-free optical fibers.

2. Description of the Related Art

Fiber optic sensors or cables including optical fibers have a variety of uses. For example, fiber optic sensors may be attached to a structure of interest in such a way that strain may be measured using conventional tools. Some examples of structures of interest include, but are not limited to, casings of oil wells, bridges, buildings, steam pipes, and any other structure where strain sensing can provide predictive data on potential failure of the structure. Some techniques used to measure strain include Fiber Bragg gratings and a Brillioun Optical Time Domain Reflectometer.

In standard telecom gel filled cables the designs have the optical fiber (also referred to as “fiber”) strain-free to ensure long life. Also, there are telecom designs that use a tight buffered fiber which can translate fiber strain to cable strain.

In FIG. 1A, a conventional loose buffer cable 100 is described. In the center is a central strength member 101 that provides tensile strength and resistance to shrinkage at cold temperatures. Around the central strength member are loose buffer tubes 102 housing the optical fibers 103. The tube can have gel in it but can also be dry or gel free. The stranding of the tubes provides a strain free window. As the cable 100 is tensioned, the fibers 103 can move radially toward the center of the cable and they only see strain once they are in contact with the inside wall of the tube toward the center of the cable. For outer protection, an outer jacket 104 made of a variety of polymers such as polyethylene, polyurethane, polyamide, etc is provided.

An example of a cable design in which the fiber is tightly buffered inside the cable is disclosed in Patent document 1 (WO2007089791), the disclosure of which is incorporated herein by reference in its entirety. Patent document 1 discloses a strain sensing device which includes an optical fiber within a sub-assembly, wherein the sub-assembly is encased in a metallic coating which is strain coupled to the sub-assembly. FIG. 1B illustrates a cross sectional view of the strain sensing device disclosed in Patent document 1. The strain sensing device includes a sub-assembly 120 containing optical fibers 160. FIG. 1B shows seven optical fibers 160 within the sub-assembly 120. The sub-assembly 120 is comprised of an inner layer 140 and a jacket 130. The optical fibers 160 are coupled to the sub-assembly 120 using coupling material 150. The sub-assembly 120 is encased within a metallic coating 110, wherein the metallic coating is strain coupled to the sub-assembly 120 by way of friction between the metallic coating and the sub-assembly. The optical fibers 160 are the strain sensing elements. Thus, strain on the metallic coating 110 travels through the entire sub-assembly 120 and is translated to the optical fibers 160 to properly measure the strain. The strain on the optical fiber 160 may then be measured using a related art measuring tool as described above. The strain on the optical device 160 may then be correlated to the strain on the structure and a potential failure of the structure may be anticipated.

The conventional technology for monitoring both the temperature and strain of a component of interest (such as a pipeline) is not very efficient. In conventional technology, the operator would put localized sensors to measure strain and temperature along the length of the component of interest. The localized sensors may or may not be optical based. Localized optical sensors utilize a fiber bragg grating which is coupled in some way to the area of interest. An interrogator is attached to the optical fiber which can sense strain on the fiber bragg grating. These types of systems often have some form of temperature compensation such as a thermocouple to record temperature so these effects can be accounted for properly. The other non-optical option is a foil gauge which uses changes in electrical conductance that occur when the foil gauge is strained or compressed to determine strain. In either case, these point sensors must each be individually mounted and each may require its own interrogator. This is not very cost effective when a pipeline can be hundreds if not thousands of km's long. It is also not very effective since the sensors are localized so much of the component is not being monitored.

Therefore, there is a need for a single device that can perform both strain and temperature measurements in a distributed manner and provide accurate results. Furthermore, it will be beneficial if the device includes an optical fiber.

### SUMMARY

Exemplary embodiments of the present invention address at least the above problems and/or disadvantages and other disadvantages not described above. Also, the present invention is not required to overcome the disadvantages described above, and an exemplary embodiment of the present invention may not overcome any of the problems listed above.

According to an exemplary embodiment, a cable comprising a strain-free fiber and a strain-coupled fiber is provided.

### BRIEF DESCRIPTION OF THE DRAWINGS

The above and other features and advantages of the present invention will become more apparent by describing in detail exemplary embodiments thereof with reference to the attached drawings in which:

FIG. 1A illustrates a prior art cable with a strain free fiber.

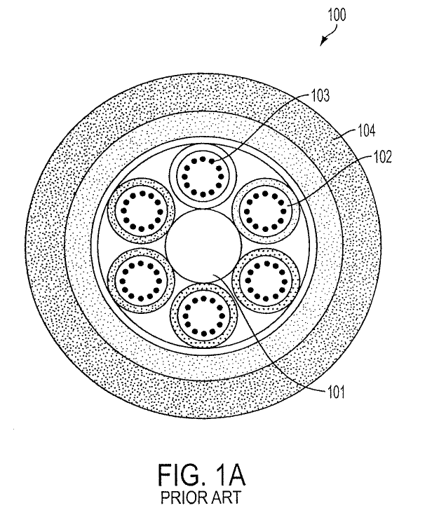

FIG. 1B illustrates a strain sensing device with an optical fiber as the strain sensing element.

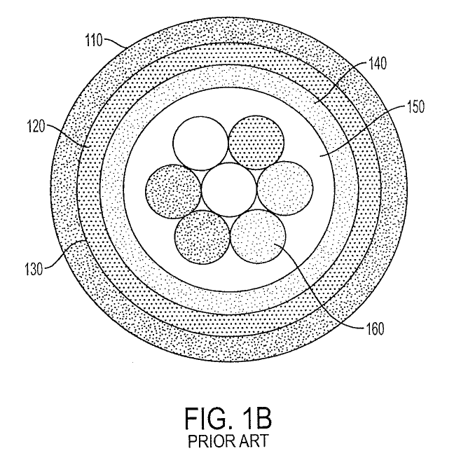

FIG. 2A illustrates a cross-sectional view of an exemplary embodiment of a cable including a strain free optical fiber and a strain coupled optical fiber.

FIG. 2B illustrates an enlarged cross-sectional view of a strain coupled assembly.

FIG. 3A illustrates a cross-sectional view of an exemplary embodiment of a cable including a strain free optical fiber and a strain coupled optical fiber.

FIG. 3B illustrates an enlarged cross-sectional view of a central element.

FIG. 4 illustrates a cross-sectional view of an exemplary embodiment of a cable including a strain free optical fiber and a strain coupled optical fiber.

### DETAILED DESCRIPTION

Exemplary embodiments of the present disclosure will now be described more fully with reference to the accompanying drawings in which same drawing reference numerals refer to the same elements. Also, well-known functions or constructions are not described in detail since they would obscure the invention with unnecessary detail.

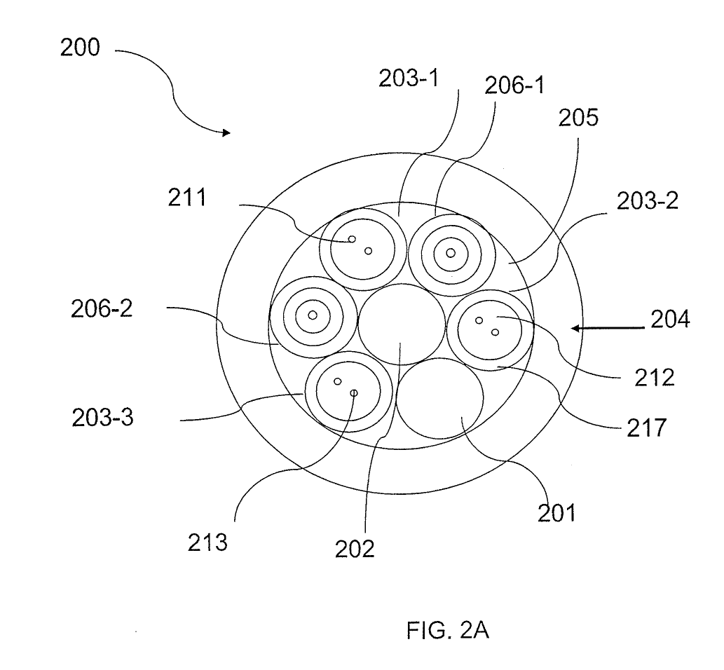

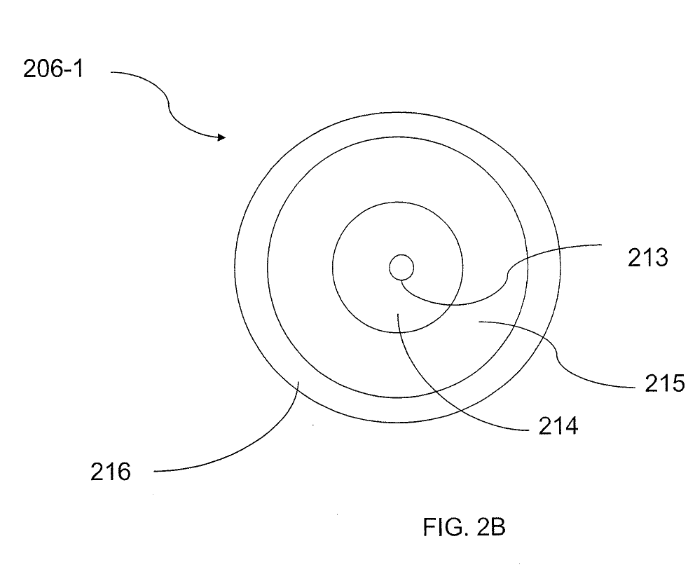

FIG. 2A illustrates a combination cable 200 according to an exemplary embodiment of the present disclosure. The combination cable includes a filler 201, a central strength element 202, a plurality of strain-coupled assemblies (206-1 and 206-2), and a plurality of strain-free assemblies (203-1, 203-2, and 203-3). The element 205 refers to a void that may be air filled or may be filled with a wax or gel.

The strain-free assemblies include a plastic tube 217 housing optical fibers 211 therein. The strain-free assemblies 203-1, 203-2, and 203-3 correspond to gel-filled tubes with excess optical fiber built into it. That is the length of the optical fiber 211 is greater than the length of the gel-filled tube in which the optical fiber 211 is housed. The reason for such an arrangement is that when the cable 200 is elongated or stretched, the optical fiber 211 is not stretched to a point and hence is not strained. The excess fiber length may be between 0 to 1% of the total fiber length but could be higher and even lower depending on what the designer is trying to achieve. The plastic tube 217 can be made from a variety of plastics, for example PBT, polypropylene, and polyethylene. The plastic tube 217 may be filled with a thixotropic gel to preclude water ingress but it is not necessary that the plastic tube 217 be gel-filled. The dimensions of the plastic tube 217, i.e., the diameter and thickness will vary depending on the design. It should be noted that the fiber 211 is strain-free for an intended tensile window, i.e., if the cable is stretched beyond a point the optical fiber may not be strain-free. The fiber in the tube is loose or strain free under the conditions with no cable tension. As the cable is tensioned, the fibers will not see strain immediately as the fibers can move radially toward the center of the cable. Once the strain is such that the fiber touches the inside wall of the tube, the fiber will begin to see strain. The cable strain to get to this point is the strain-free window of the cable. Exemplarily, the cable may be designed such that the strain-free window is approximately between 0.1%-4% of the cable strain. Preferably, the strain-free window is approximately between 1%-2% of the cable strain. The layout of the gel-filled tubes, size of the tube, wall thickness of the tube, number of fibers, center member diameter and the starting excess fiber length in the tube all play a role in the determination of the strain free window.

The central strength element 202 is used to provide strength and rigidity to the cable 200 and may be made of glass or appropriate material. The central strength element 202 is preferably made from a high modulus material with a low temperature coefficient of expansion such as steel or glass re-enforced plastic and is sized appropriately for the geometry and the characteristics desired. Exemplarily, the diameter of the central strength element 202 may be 3.2 mm but can vary from 0.4 mm to 5 mm in dimension. The central strength element 202 increases the tensile performance of the cable, limits the elongation of the cable under tension thus improving the strain free window and limits the contraction of the cable at cold temperature which allows for continued optical transmission by preventing the optical fibers from being bent below the bend radius to where the light will escape the core of the optical fiber. The filler 201 may or may not be used in the cable 200 and is usually provided for geometry purposes. The filler 201 may be made of plastic or similar materials. Filler rods are used to fill in spaces inside of the cable to allow for the overall geometry of the cable to be met. Filler rods can be made from a variety of materials such as polypropylene, polyethylene or others. Exemplarily, the filler size may vary from approximately 1.2 mm to 4 mm in dimension. The complete structure described above is provided in a plastic tube 204. The plastic tube 204 may be a plastic extruded coating made of polyethylene. The tube 204 may also be made from other appropriate plastic materials. It is also possible that the tube 204 is a metal tube. All the materials and dimensions described above are for purposes of illustrations and various different sizes and materials will be apparent to one of ordinary skill.

A cross-section of the strain-coupled (strain-sensing) assembly 206-1 is described next with reference to FIG. 2B. It will be understood that the structure of strain-coupled assembly 206-2 is the same as that of strain-coupled assembly 206-1 and hence its description is omitted. The assembly 206-1 includes an optical fiber 213 surrounded by a plastic covering 214. The fiber diameter is typically 245 um but may vary depending on the fiber used. The plastic covering 214 may be made of a suitable polymer which is UV curable such as acrylate, PVC, polyester, polyamide, PBT, polyethylene, etc. The thickness of the plastic covering 214 may range from 300 um (0.3 mm) to 1.2 mm. A layer of aramid 215 or any other suitable material is provided over the plastic covering 214 and the complete package is surrounded by an outer jacket 216. The outer jacket 216 can be made from various materials such as polyurethane, polyamide, polyethyelene, polypropylene, rubber compounds, PVC, etc. The thickness of the outer jacket may vary from 0.5 mm-˜4 mm, and in an exemplary embodiment, the thickness of the outer jacket 216 may be approximately 3 mm. The outer jacket may be applied with high pressure while the core is exposed to vacuum thus making the components of the cable couple together in such a way that applied strain to the jacket translates to the inner optical fiber without slippage between the various layers. In the strain-coupled assembly 206-1, the optical fiber 213 is locked in place such that strain on the cable translates into strain on the optical fiber.

One use for the cable 200 would be to monitor long distance conditions such as movement in the cable (strain) and temperature of an object. An example of the object would be a pipeline. Exemplarily, the technology used to monitor the conditions may be Brillioun technology, which uses the characteristic of an optical fiber where an incident pulse of light goes down the fiber at a certain wavelength and light pulses return at different wavelengths. There are two peaks that return back and they are called Brillioun peaks. These peaks are strain sensitive. Strain on the fiber can be from a mechanical stretching of the fiber or from a temperature change where the fiber gets longer just due to temperature increase.

The cable 200 along with Brillioun technology would enable measuring of the true strain on the cable by separating out mechanical strain from temperature induced strain. By having a cable where at least one optical fiber is locked in place, i.e., the strain-coupled fiber, the user can get “total strain” measurements from this fiber. As the same cable 200 also has at least one optical fiber that is strain free (free from mechanical strain) over an intended tensile operating window, strain due to temperature can be accurately measured as there is no other mechanical component involved. By having such a setup, the user can obtain the actual cable strain by subtracting out the temperature component from the total strain measured using the strain-coupled fiber.

Conceivably, two separate cables can be deployed which may accomplish the same objective of measuring strain and temperature as cable structures are known that lock the fiber in and others where the fiber is strain free. The disadvantage of such a setup is that with the cables being separate the temperature of the two cables may not be the same and the cable lengths may vary based on how the cable was installed, i.e. from point A to point B the strain cable may be 100 m in length where the strain free cable might be 102 m. This will create inaccuracies in measurement over long distances. By having both components in one cable, this issue goes away and it results in only one cable having to be deployed, thereby saving costs and also providing more accurate results.

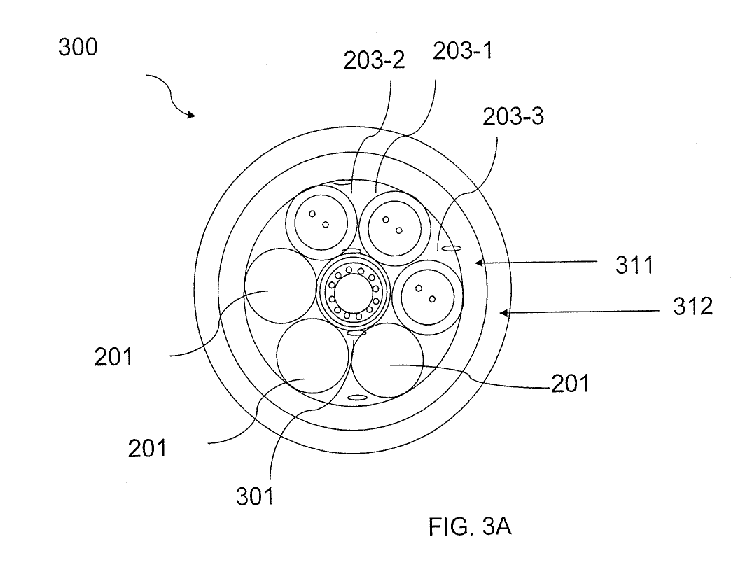

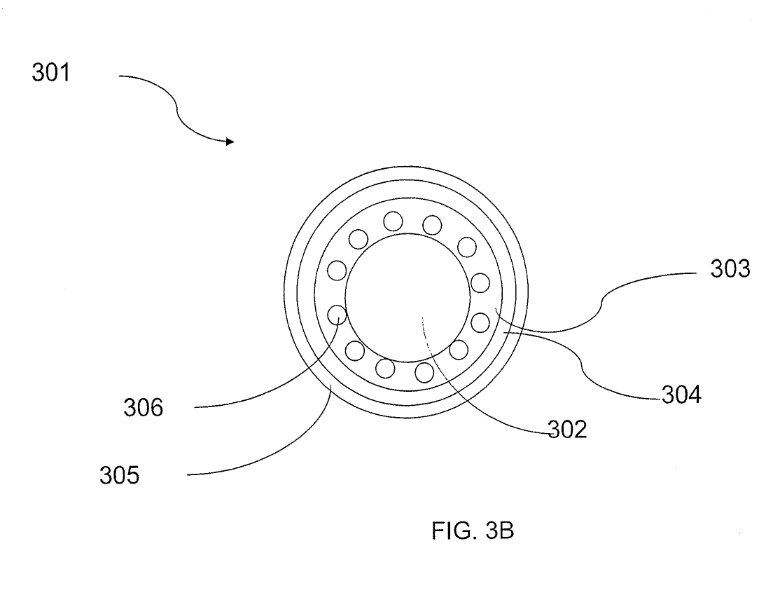

FIG. 3A illustrates another exemplary embodiment showing the cross-section of a cable with a strain-free optical fiber and a strain-coupled optical fiber. In FIG. 3, a plurality of strain-free assemblies 203-1, 203-2, and 203-3 are shown housed in the cable 300. Exemplarily, three strain-free assemblies are shown. However, there can be more than or less than three strain-free assemblies. Fillers 201 are provided for geometry purposes. A central element 301 that includes a central strength member 302 and optical fibers 306 is provided in the cable 300. The central element 301 corresponds to a strain-coupled assembly. The central element 301 has fibers 306 encased in a matrix that holds the fibers in place. The complete structure is encompassed by elements 311 and 312. 311 and 312 are extruded polymer jackets to provide protection for the cable core. Jacket materials are typically polyethylene and or polyamide but could be other materials as well depending on the attributes the cable designer is looking for, i.e. chemical resistance, crush resistance, abrasion protection, etc.

FIG. 3B illustrates a cross-section of the central element 301 with optical fibers in further detail. In this structure there is a center strength member 302 that provides for the functions described previously for the central strength element. The optical fibers 306 are stranded around the center strength member 302 and are encased in a suitable material to couple the fibers to the strength member 302. A UV curable silicone material 303 is applied over the fibers 306. Over the silicone material is a UV curable epoxy 304, which provides protection to the optical fibers and the silicone layer. Over the epoxy coating 304 is a polyester jacket 305 to provide further protection to the core. The silicone, epoxy and polyester layers can be replaced with a single material as well. The combination described in this exemplary embodiment was chosen due to the added protection this package provides to the optical fibers.

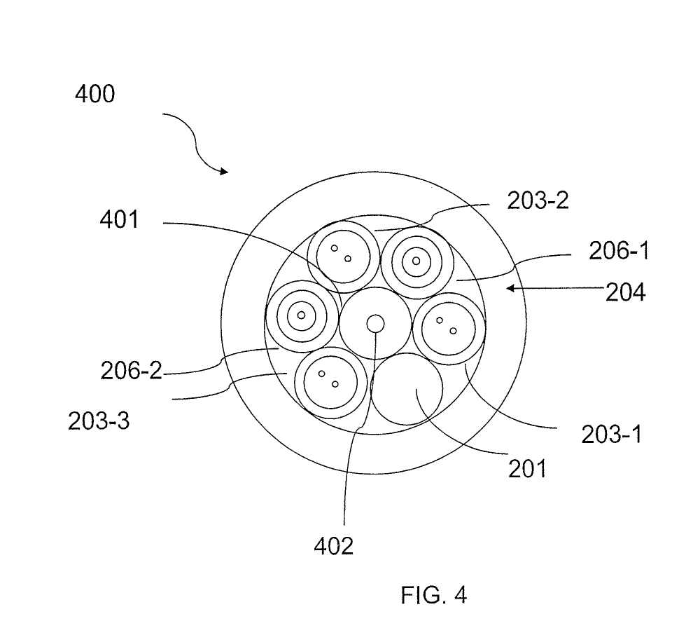

FIG. 4 illustrates a cross-sectional view of yet another exemplary embodiment of a cable 400 with a strain-free optical fiber and a strain-coupled optical fiber. Inside a plastic extrusion 204, a plurality of strain-free assemblies 203-1, 203-2, and 203-3 and strain-coupled assemblies 206-1, 206-2 are provided. A filler 201 is also provided for geometry purposes. A central strength member 401 with an optical fiber 402 encased therein is also provided. This central strength member 401 with an optical fiber encased inside is known in the industry and is offered by AFL Telecommunication LLC. under the trade name FiberRod. In this exemplary embodiment, the central strength member 401 is provided with the fiber inside of the central strength member to provide another strain sensing element option. The central strength member 401 is such that the optical fiber 402 is coupled to the cable structure.

The exemplary cable configurations described above may be used for a variety of purposes and especially where there is interest in knowing physical movements of long length structures. For example, these cables may be used with pipelines where understanding strain on the pipeline due to seismic shifts can provide the operator with predictive information so they can avoid damage to the pipeline and possibly avoid leaks in the pipeline. Another potential use is for land or rock slide areas. In this application, the cable can provide information to the user that allows them to proactively address areas such as roads or dwellings to ensure personnel are not endangered.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A cable comprising:
a first strain-free fiber; and
a first strain-coupled fiber.

2. The cable according to claim 1, further comprising:
a second strain-free fiber;
a second strain-coupled fiber; and
a central member.

3. The cable according to claim 2, wherein the central member includes a central strength member and a third strain-coupled fiber.

4. The cable according to claim 1, wherein the first strain-free fiber has a strain-free window approximately between 0.1 percent-4 percent of the cable strain.

5. The cable according to claim 4, wherein the strain-free window is approximately between 1 percent-2 percent of the cable strain.

6. The cable according to claim 2, wherein the first-strain free fiber and the second strain-free fiber is housed in a gel-filled tube.

7. A cable comprising:
a first strain-free assembly including a first optical fiber; and
a first strain-coupled assembly including a second optical fiber.

8. The cable according to claim 7, wherein the first strain-free assembly includes a gel-filled tube housing the first optical fiber.

9. The cable according to claim 7, wherein the first strain-coupled assembly includes a plastic layer covering the second optical fiber such that the second optical fiber is strained under all operating conditions if the cable is strained.

10. The cable according to claim 7, wherein the first strain-coupled assembly includes a central element encasing the second optical fiber and a third optical fiber in a matrix such that the second optical fiber and the third optical fiber are strained under all operating conditions if the cable is strained.

11. The cable according to claim 7, wherein the first optical fiber has a strain-free window approximately between 0.1 percent-4 percent of the cable strain.

12. The cable according to claim 11, wherein the strain-free window is approximately between 1 percent-2 percent of the cable strain.
